(19) United States
(12) Patent Application Publication
(10) Pub. No.: US 2017/0163711 A1
(43) Pub. Date: Jun. 8, 2017

(54) METHOD AND DEVICE FOR DISPLAYING A PAGE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Shangliang CI, Tianjin (CN)

(21) Appl. No.: 15/247,849

(22) Filed: Aug. 25, 2016

Related U.S. Application Data
(63) Continuation of application No. PCT/CN2016/088956, filed on Jul. 6, 2016.

(30) Foreign Application Priority Data
Dec. 4, 2015 (CN) 201510884306.2

(51) Int. Cl. H04L 29/08; G06F 17/30

(52) U.S. Cl. CPC H04L 67/02; H04L 67/10; G06F 17/30887; G06F 17/30902

(57) ABSTRACT

Disclosed are a method and device for displaying a page, where an input page retrieval request including a URL address is received; if there are local buffer data corresponding to the URL address, then a corresponding page will be generated according to the buffer data; the page retrieval request will be transmitted to a server corresponding to the URL address; and if it is determined that data corresponding to the URL address stored in the server are updated relative to the buffer data, then the generated page will be updated with the data corresponding to the URL address stored in the server.

### CROSS REFERENCE TO RELATED APPLICATIONS

This application is a continuation of International Application No. PCT/CN2016/088956, filed on Jul. 6, 2016, which is based upon and claims priority to Chinese Patent Application No. 201510884306.2, filed with the Chinese Patent Office on Dec. 4, 2015 and entitled “Method and device for displaying a page”, which is hereby incorporated by reference in its entirety.

### TECHNICAL FIELD

The present disclosure relates to the field of communications, and particularly to a method for displaying a page, electronic device and storage medium.

### BACKGROUND

As the Internet is being developed, various terminals (e.g., a handset, a PAD, etc.) have been widely applied due to their rapid communication and convenient operations. At present, the terminals can be provided with standalone operating systems, and their users can install applications available from third-party providers as needed to thereby extend functions of the terminals using the applications.

Referring to FIG. 1, a terminal presents a page requested by a user in the prior art in the following process:

In the step 100, the terminal receives an instruction input by the user.

Where the instruction input by the user includes an address link, etc.

In the step 110, the terminal generates a data retrieval request according to the address link in the instructions.

In the step 120, the terminal transmits the data retrieval request to the network side.

In the step 130, the network side generates a data packet including a page corresponding to the address link in response to the data retrieval request, and transmits the data packet to the terminal.

In the step 140, the terminal presents the corresponding page locally according to the data packet.

The inventors have identified from the process above that the terminal has to wait for the data packet including the page information transmitted by the network side, and will not present the page requested by the user to the user until the data packet is received, so if there is a poor network condition, then it will take a long period of time for the terminal to obtain the data packet, thus increasing the length of time for the terminal to present the requested page to the user, which may degrade the experience of the user.

As can be apparent, there is such a problem in the prior art that the terminal presenting the page may respond inefficiently and present the page slowly.

### SUMMARY

Embodiments of the disclosure provide a method for displaying a page, electronic device and storage medium so as to address such a problem in the prior art that the terminal presenting the page may respond inefficiently and present the page slowly.

Particular technical solutions according to the embodiments of the disclosure are as follows:

An embodiment of the disclosure provides a method for displaying a page, executed by an electronic device, the method including:

receiving an input page retrieval request including a Uniform Resource Locator (URL) address;

if there are local buffer data corresponding to the URL address, then generating a corresponding page according to the buffer data;

transmitting the page retrieval request to the server corresponding to the URL address; and
if data corresponding to the URL address stored in the server are updated relative to the buffer data, then updating the generated page with the data corresponding to the URL address stored in the server.

An embodiment of the disclosure provides an electronic device for displaying a page the electronic device including:

at least one processor; and
a memory communicably connected with the at least one processor for storing instructions executable by the at least one processor, wherein execution of the instructions by the at least one processor causes the at least one processor:

to receive an input page retrieval request comprising a Uniform Resource Locator (URL) address;

if there are local buffer data corresponding to the URL address, then to generate a corresponding page according to the buffer data;

to transmit the page retrieval request to the server corresponding to the URL address; and

if data corresponding to the URL address stored in the server are updated relative to the buffer data, then to update the generated page with the data corresponding to the URL address stored in the server

An embodiment of the disclosure provides a non-transitory computer-readable storage medium storing executable instructions that, when executed by an electronic device with a touch-sensitive display, cause the electronic device:

to receive an input page retrieval request comprising a Uniform Resource Locator (URL) address;

if there are local buffer data corresponding to the URL address, then to generate a corresponding page according to the buffer data;

to transmit the page retrieval request to the server corresponding to the URL address; and

if data corresponding to the URL address stored in the server are updated relative to the buffer data, then to update the generated page with the data corresponding to the URL address stored in the server.

The embodiments of the disclosure provide a method for displaying a page, electronic device and storage medium where the input page retrieval request including the URL address is received; if there are local buffer data corresponding to the URL address, then the corresponding page will be generated according to the buffer data; the page retrieval request will be transmitted to the server corresponding to the URL address; and if it is determined that the data corresponding to the URL address stored in the server are updated relative to the buffer data, then the generated page will be updated with the data corresponding to the URL address stored in the server. With the technical solutions according to the embodiments of the disclosure, the buffer data corresponding to the respective URL addresses are preset locally in the terminal, and the terminal can display the corresponding page according to the buffer data, so that the terminal can present rapidly the page corresponding to the URL address requested by the user to thereby improve the efficiency of displaying the page on the terminal in response, and shorten the period of time for the user to wait; and moreover the terminal generating the page according to the buffer data can check the network side data corresponding to the page for a data update, and if there is an update, then the terminal will retrieve and present the updated data, thus guaranteeing the accuracy of the page presented on the terminal in the synchronous update mode.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of displaying a page on a terminal in the prior art;

FIG. 2 is a schematic architectural diagram of a communication system according to an embodiment of the disclosure;

FIG. 3 is a flow chart of displaying a page on a terminal according to a first embodiment of the disclosure;

FIG. 4 is a flow chart of displaying a page on a terminal according to a second embodiment of the disclosure;

FIG. 5 is a schematic structural diagram of an device for display a page according to a third embodiment of the disclosure; and

FIG. 6 is a schematic structural diagram of a terminal according to a fourth embodiment of the disclosure;

FIG. 7 is a schematic structural diagram of an electronic device according to a fifth embodiment of the disclosure.

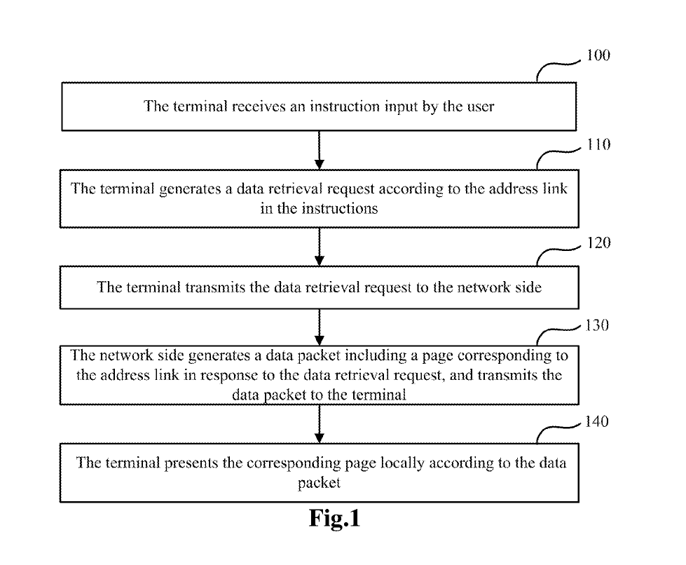

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

The embodiments of the disclosure will be described below in further details with reference to the drawings.

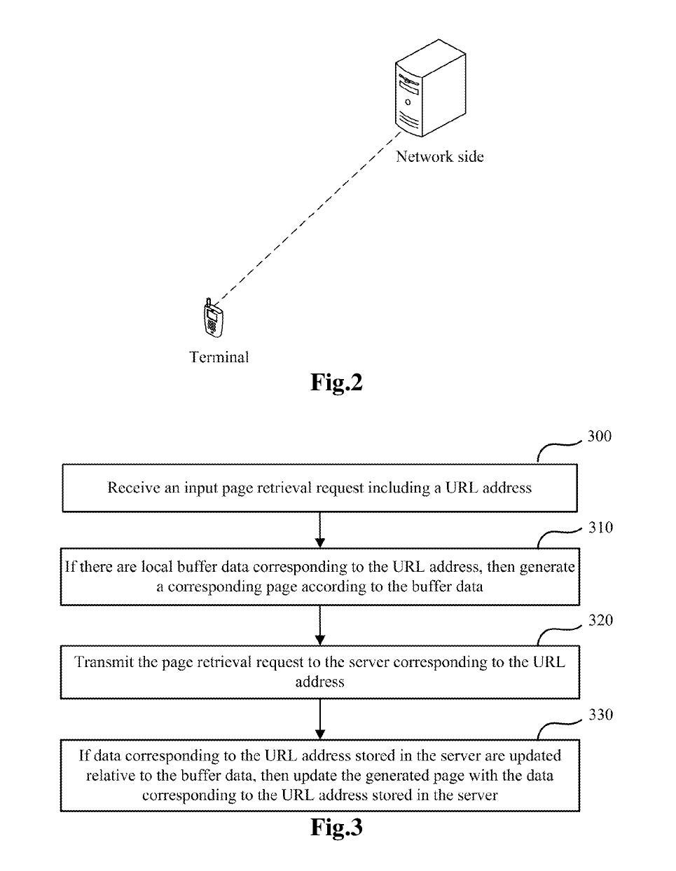

Referring to FIG. 2 which is a schematic architectural diagram of a communication system according to an embodiment of the disclosure, the communication system includes a terminal and a network side device, where the terminal is a device capable of communication, the terminal is provided with a user interaction interface, e.g., a smart TV set, a personal computer, a handset, a tablet computer, etc., and an operating system loaded in the terminal can be the Windows operating system, the Android operating system, or the IOS operating system; and the network side device is a server providing network information.

### First Embodiment

Referring to FIG. 3, a terminal or an electronic device displays a page in an embodiment of the disclosure as follows:

The step 300 is to receive an input page retrieval request including a Uniform Resource Locator (URL) address.

In an embodiment of the disclosure, the terminal receives the input page retrieval request including the URL address which can be a URL address input by a user in an address bar, or can be any one address link in a web navigation page or a search result page, or can be a client application installed locally on the terminal, where the client application also corresponds to a unique URL address.

Optionally the terminal can receive the page retrieval request input by a user, or can receive the page retrieval request input by another device.

The step 310 is, if there are local buffer data corresponding to the URL address, to generate a corresponding page according to the buffer data.

In an embodiment of the disclosure, there are a number of URL addresses, and buffer data corresponding thereto locally in the terminal, and the terminal can generate a corresponding page for each URL address. For example, if an input URL address is “www.sohu.com”, then buffer data corresponding to the URL address will be data for generating a home page of SOHU; and if the terminal runs a local client application “xx”, then buffer data corresponding to the URL address will be data for generating a home page of xx.

Furthermore if there are no buffer data corresponding to the URL address in the terminal, then the page retrieval request will be transmitted directly to a server corresponding to the URL address.

With the technical solution above, the terminal presets the URL addresses and the buffer data corresponding thereto locally, and upon reception of the input page retrieval request, the terminal can directly invoke locally the buffer data corresponding to the URL address requested by the user, and generate directly the corresponding page according to the buffer data without waiting for the network side to transmit the data corresponding to the URL address requested by the user to the terminal, to thereby shorten the length of time for the user to wait, and improve the efficiency of presenting the page on the terminal.

The step 320 is to transmit the page retrieval request to the server corresponding to the URL address.

In an embodiment of the disclosure, the terminal transmits the page retrieval request to the server corresponding to the URL address to request the server for transmitting the data corresponding to the page requested by the terminal to the terminal.

Optionally the terminal can transmit wirelessly the page retrieval request to the server corresponding to the URL address, or can transmit a wired manner the page retrieval request to the server corresponding to the URL address in.

In an embodiment of the disclosure, the step 310 and the step 320 are performed concurrently. With the technical solution above, the terminal displaying the page according to the local buffer data can transmit the page retrieval request to the network side synchronously in multiple threads operating concurrently to thereby improve the efficiency of displaying the page, and shorten the period of time for the user to wait.

The step 330 is, if data corresponding to the URL address stored in the server are updated relative to the buffer data, to update the generated page with the data corresponding to the URL address stored in the server.

In an embodiment of the disclosure, the buffer data stored locally in the terminal includes at least the time when the buffer data are obtained, which is a point of time when the terminal obtains the buffer data.

Optionally it is determined that the data corresponding to the URL address stored in the server are updated relative to the buffer data, by obtaining the time when the data corresponding to the URL address stored in the server are obtained; comparing the time when the buffer data are obtained, in the locally stored buffer data with the time when the data corresponding to the URL address stored in the server are obtained; and if the time when the buffer data are obtained, in the buffer data is later than the time when the data corresponding to the URL address stored in the server are obtained, then determining that the data corresponding to the URL address stored in the server are updated relative to the buffer data.

In order to alleviate a burden on the terminal, optionally the server can determine whether the data corresponding to the URL address stored in the server are updated relative to the buffer data; and particularly the terminal transmits the time when the buffer data are obtained, in the buffer data to the server; and the server compares the time when the buffer data are obtained, in the locally stored buffer data with the time when the data corresponding to the URL address stored in the server are obtained, and if the time when the buffer data are obtained, in the buffer data is later than the time when the data corresponding to the URL address stored in the server are obtained, then the server will determine that the data corresponding to the URL address stored in the server are updated relative to the buffer data, and transmit the data corresponding to the URL address to the terminal.

The page presented on the terminal typically includes a text corresponding to string of characters data, and a picture corresponding to picture data, that is, the buffer data include picture buffer data and string of characters buffer data, and the data include picture data and string of characters data, so that if the time when the buffer data are obtained, in the buffer data is later than the time when the data corresponding to the URL address stored in the server are obtained, then it will be determined that the data corresponding to the URL address stored in the server are updated relative to the buffer data, particularly as follows:

If the time when the string of characters data are obtained, in the string of characters buffer data is later than the time when the string of characters data corresponding to the URL address stored in the server are obtained, then it will be determined that the string of characters data corresponding to the URL address stored in the server are updated relative to the string of characters buffer data; and

If the time when the picture data are obtained, in the picture buffer data is later than the time when the picture data corresponding to the URL address stored in the server are obtained, then it will be determined that the picture data corresponding to the URL address stored in the server are updated relative to the picture buffer data.

Optionally the generated page is updated with the data corresponding to the URL address stored in the server particularly as follows: if the string of characters data corresponding to the URL address stored in the server are updated relative to the string of characters buffer data, then updating the text information in the generated page using the string of characters data corresponding to the URL address stored in the server; and if the picture data corresponding to the URL address stored in the server are updated relative to the picture buffer data, then updating the picture information in the generated page using the picture data corresponding to the URL address stored in the server.

In the process above, the server can update the string of characters data and the picture data respectively; and since a large space is occupied by the picture data, the terminal can compare the string of characters data and the picture data separately, that is, the terminal firstly compares the string of characters data for an update, and then compares the picture buffer data for an update; and if there is no update to the picture buffer data, then the terminal will not retrieve the picture data corresponding to the URL address stored in the server, but only retrieve the updated string of characters data to thereby reduce the amounts of data transmitted between the terminal and the server, save a system bandwidth, and improve the efficiency of data transmission, further improve the efficiency of displaying the page on the terminal, and shorten the length of time for the terminal to wait.

Furthermore the terminal updating the generated page updates the locally stored buffer data with the data corresponding to the URL address stored in the server.

With the technical solution above, the buffer data corresponding to the respective URL addresses are preset locally in the terminal, and the terminal can display the corresponding page according to the buffer data, so that the terminal can present rapidly the page corresponding to the URL address requested by the user to thereby improve the efficiency of displaying the page on the terminal in response, and shorten the period of time for the user to wait; and moreover the terminal generating the page according to the buffer data can check the network side data corresponding to the page for a data update, and if there is an update, then the terminal will retrieve and present the updated data, thus guaranteeing the accuracy of the page presented on the terminal in the synchronous update mode.

### Second Embodiment

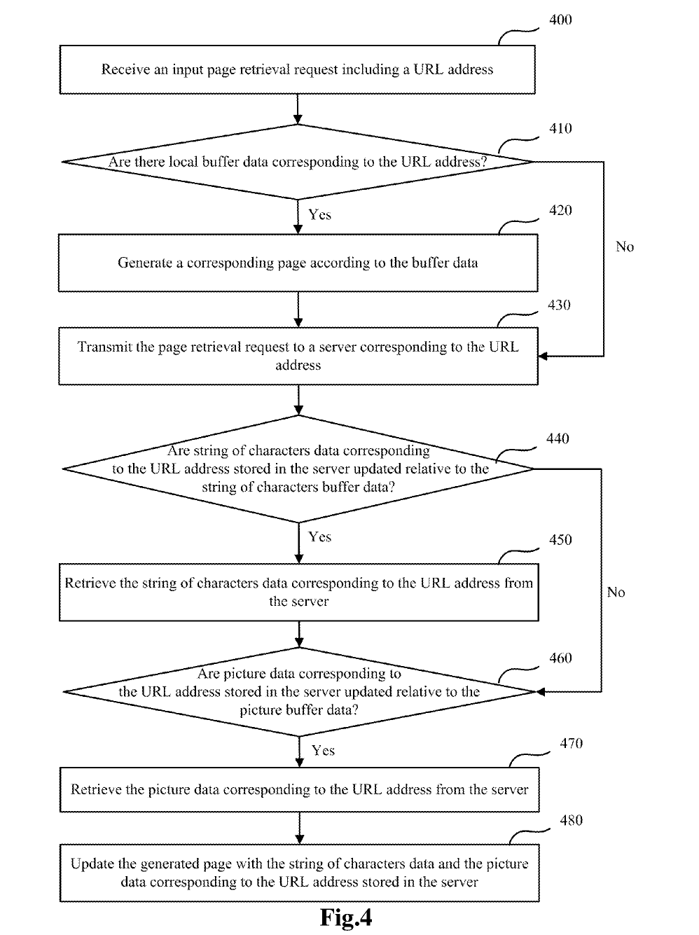

Based upon the technical solution according to the first embodiment above, referring to FIG. 4, a process for the terminal to display a page will be described below in details in connection with a particular application scenario:

The step 400 is to receive an input page retrieval request including a URL address.

In an embodiment of the disclosure, the terminal receives the input page retrieval request including the URL address which can be a URL address input by a user in an address bar, or can be any one address link in a web page navigation page or a search result page, or can be a client application installed locally on the terminal, where the client application also corresponds to a unique URL address.

The step 410 is to determine whether there are local buffer data corresponding to the URL address, and if so, then the flow will proceed to the step 420; otherwise, the flow will proceed to the step 430.

The step 420 is to generate a corresponding page according to the buffer data.

The step 430 is to transmit the page retrieval request to a server corresponding to the URL address.

The step 440 is to determine whether string of characters data corresponding to the URL address stored in the server are updated relative to the string of characters buffer data, and if so, then the flow will proceed to the step 450; otherwise, the flow will proceed to the step 460.

The step 450 is to retrieve the string of characters data corresponding to the URL address from the server.

The step 460 is to determine whether picture data corresponding to the URL address stored in the server are updated relative to the picture buffer data, and if so, then the flow will proceed to the step 470; otherwise, the flow will proceed to the step 480.

The step 470 is to retrieve the picture data corresponding to the URL address from the server.

The step 480 is to update the generated page with the string of characters data and the picture data corresponding to the URL address stored in the server.

### Third Embodiment

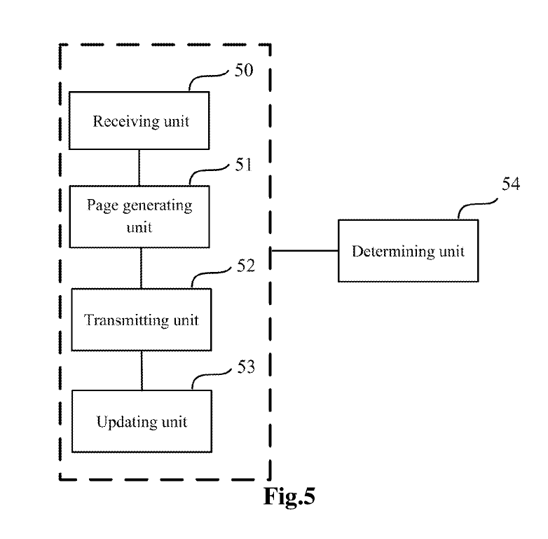

Based upon the technical solutions according to the first embodiment and the second embodiment, referring to FIG. 5, an embodiment of the disclosure further provides an device for displaying a page interface, where the device includes a receiving unit 50, a page generating unit 51, a transmitting unit 52, and an updating unit 53, where:

The receiving unit 50 is configured to receive an input page retrieval request including a URL address;

The page generating unit 51 is configured, if there are local buffer data corresponding to the URL address, to generate a corresponding page according to the buffer data;

The transmitting unit 52 is configured to transmit the page retrieval request to the server corresponding to the URL address; and

The updating unit 53 is configured, if data corresponding to the URL address stored in the server are updated relative to the buffer data, to update the generated page with the data corresponding to the URL address stored in the server.

Furthermore the buffer data includes at least the time when the buffer data are stored; and the device further includes a determining unit 54 configured: to obtain the time when the data corresponding to the URL address stored in the server are obtained; to compare the time when the buffer data are obtained, in the locally stored buffer data with the time when the data corresponding to the URL address stored in the server are obtained; and if the time when the buffer data are obtained, in the buffer data is later than the time when the data corresponding to the URL address stored in the server are obtained, to determine that the data corresponding to the URL address stored in the server are updated relative to the buffer data.

Optionally the buffer data include picture buffer data and string of characters buffer data, and the data include picture data and string of characters data; and the determining unit 54 configured, if the time when the buffer data are obtained, in the buffer data is later than the time when the data corresponding to the URL address stored in the server are obtained, to determine that the data corresponding to the URL address stored in the server are updated relative to the buffer data is configured: if the time when the string of characters data are obtained, in the string of characters buffer data is later than the time when the string of characters data corresponding to the URL address stored in the server are obtained, to determine that the string of characters data corresponding to the URL address stored in the server are updated relative to the string of characters buffer data; and if the time when the picture data are obtained, in the picture buffer data is later than the time when the picture data corresponding to the URL address stored in the server are obtained, to determine that the picture data corresponding to the URL address stored in the server are updated relative to the picture buffer data.

Optionally the updating unit 53 is configured: if the string of characters data corresponding to the URL address stored in the server are updated relative to the string of characters buffer data, to update text information in the generated page using the string of characters data corresponding to the URL address stored in the server; and if the picture data corresponding to the URL address stored in the server are updated relative to the picture buffer data, to update picture information in the generated page using the picture data corresponding to the URL address stored in the server.

Furthermore the updating unit 53 is further configured to update the locally stored buffer data with the data corresponding to the URL address stored in the server while the generated page are being updated with the data corresponding to the URL address stored in the server.

### Fourth Embodiment

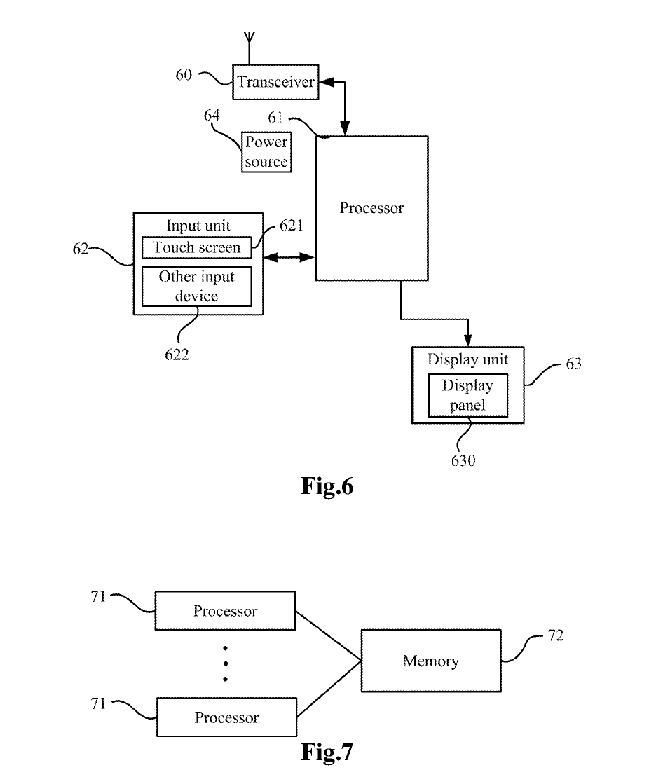

Based upon the technical solutions according to the first embodiment and the second embodiment, referring to FIG. 6, an embodiment of the disclosure further provides a terminal including a transceiver 60 and a processor 61, where:

The transceiver 60 is configured to receive an input page retrieval request including a URL address;

The processor 61 is configured, if there are local buffer data corresponding to the URL address, to generate a corresponding page according to the buffer data;

The transceiver 60 is further configured to transmit the page retrieval request to the server corresponding to the URL address; and

The processor 61 is further configured, if data corresponding to the URL address stored in the server are updated relative to the buffer data, to update the generated page with the data corresponding to the URL address stored in the server.

Optionally the terminal further includes an input unit 62 configured to receive input numeric or character information, and to generate a button signal input related to user setting and function control;

Particularly if the terminal is a touch input device, then the input unit 62 can include a touch screen 621 and another input device 622. The touch screen 621, also referred to as a touch control panel, can collect a touch operation by a user thereon or in proximity thereto (e.g., an operation by the user on or nearby the touch screen 621 using a finger, a stylus, or any other appropriate object or attachment), and drive a corresponding connected device by preset program. Optionally the touch screen 621 can include two components which are a touch detection device and a touch controller, where the touch detection device detects the position of touching by the user, detects a signal as a result of the touch operation, and transfers the signal to the touch controller; and the touch controller receives the touch signal from the touch detection device and converts it into coordinates of a touch point, and further transfers them to the processor 61, and can receive and execute a command sent by the processor 61. Moreover the touch screen 621 can be embodied in various types of resistive, capacitive, infrared, surface sound wave and other types. The input unit 62 can further include another input device in addition to the touch screen 621. Particularly the other input device 622 can include but will not be limited to one or more of a physical keyboard, functional keys (e.g., volume control press keys, a power-on or-off press key, etc.), a track ball, a mouse, a joystick, etc.

Optionally the buffer data includes at least the time when the buffer data are stored; and the processor 61 is configured: to obtain the time when the data corresponding to the URL address stored in the server are obtained; to compare the time when the buffer data are obtained, in the locally stored buffer data with the time when the data corresponding to the URL address stored in the server are obtained; and if the time when the buffer data are obtained, in the buffer data is later than the time when the data corresponding to the URL address stored in the server are obtained, to determine that the data corresponding to the URL address stored in the server are updated relative to the buffer data.

Optionally the buffer data include picture buffer data and string of characters buffer data, and the data include picture data and string of characters data; and the processor 61 configured, if the time when the buffer data are obtained, in the buffer data is later than the time when the data corresponding to the URL address stored in the server are obtained, to determine that the data corresponding to the URL address stored in the server are updated relative to the buffer data is configured:

If the time when the string of characters data are obtained, in the string of characters buffer data is later than the time when the string of characters data corresponding to the URL address stored in the server are obtained, to determine that the string of characters data corresponding to the URL address stored in the server are updated relative to the string of characters buffer data; and if the time when the picture data are obtained, in the picture buffer data is later than the time when the picture data corresponding to the URL address stored in the server are obtained, to determine that the picture data corresponding to the URL address stored in the server are updated relative to the picture buffer data.

Optionally the processor 61 is configured: if the string of characters data corresponding to the URL address stored in the server are updated relative to the string of characters buffer data, to update text information in the generated page using the string of characters data corresponding to the URL address stored in the server; and if the picture data corresponding to the URL address stored in the server are updated relative to the picture buffer data, to update picture information in the generated page using the picture data corresponding to the URL address stored in the server.

Optionally the processor 61 is further configured to update the locally stored buffer data with the data corresponding to the URL address stored in the server while the generated page are being updated with the data corresponding to the URL address stored in the server.

Furthermore the terminal further includes a display unit 63 configured to present an input interface including a virtual keypad. Furthermore the display unit 63 is further configured to display information input by the user, or information provided to the user, and various menus provided by the processor 61, where optionally the display unit 63 includes a display panel 630. Optionally the display panel 630 can be configured in the form of a Liquid Crystal Display (LCD), an Organic Light Emitting Diode (OLED) display, etc. Furthermore the display unit 63 above can further include a touch screen (not illustrated) which can overlie the display panel 630, where if the touch screen detects a touch operation thereon or proximate thereto, then the touch screen will transmit it to the processor 61, so that the processor 61 can determine the type of the touch event, and thereafter provide a corresponding visual output on the display panel 630 according to the type of the touch event. The touch screen and the display panel 630 can operate as two separate components to input and output information, but the touch screen and the display screen 630 can alternatively be integrated to input and output information in some embodiments.

Furthermore the device further includes a power source 64 configured to power the respective components in the terminal.

In summary, in the embodiments of the disclosure, the input page retrieval request including the URL address is received; if there are local buffer data corresponding to the URL address, then the corresponding page will be generated according to the buffer data; the page retrieval request will be transmitted to the server corresponding to the URL address; and if it is determined that the data corresponding to the URL address stored in the server are updated relative to the buffer data, then the generated page will be updated with the data corresponding to the URL address stored in the server. With the technical solutions according to the embodiments of the disclosure, the buffer data corresponding to the respective URL addresses are preset locally in the terminal, and the terminal can display the corresponding page according to the buffer data, so that the terminal can present rapidly the page corresponding to the URL address requested by the user to thereby improve the efficiency of displaying the page on the terminal in response, and shorten the period of time for the user to wait; and moreover the terminal generating the page according to the buffer data can check the network side data corresponding to the page for a data update, and if there is an update, then the terminal will retrieve and present the updated data, thus guaranteeing the accuracy of the page presented on the terminal in the synchronous update mode.

The embodiments of the device described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

### Fifth Embodiment

Based upon the technical solutions according to the first embodiment and the second embodiment, referring to FIG. 7, an embodiment of the disclosure further provides an electronic device, including: at least one processor 71; and a memory 72 communicably connected with the at least one processor 71 for storing instructions executable by the at least one processor 71, wherein execution of the instructions by the at least one processor 71 causes the at least one processor 71:

to receive an input page retrieval request comprising a Uniform Resource Locator (URL) address;

if there are local buffer data corresponding to the URL address, then to generate a corresponding page according to the buffer data;

to transmit the page retrieval request to the server corresponding to the URL address; and

if data corresponding to the URL address stored in the server are updated relative to the buffer data, then to update the generated page with the data corresponding to the URL address stored in the server.

Optionally, the buffer data includes at least the time when the buffer data are stored; and execution of the instructions by the at least one processor 71 causes the at least one processor 71: to obtain the time when the data corresponding to the URL address stored in the server are obtained; to compare the time when the buffer data are obtained, in the locally stored buffer data with the time when the data corresponding to the URL address stored in the server are obtained; and, if the time when the buffer data are obtained, in the buffer data is later than the time when the data corresponding to the URL address stored in the server are obtained, to determine that the data corresponding to the URL address stored in the server are updated relative to the buffer data.

Optionally the buffer data include picture buffer data and string of characters buffer data, and the data include picture data and string of characters data; and execution of the instructions by the at least one processor 71 causes the at least one processor 71, if the time when the buffer data are obtained, in the buffer data is later than the time when the data corresponding to the URL address stored in the server are obtained, to determine that the data corresponding to the URL address stored in the server are updated relative to the buffer data, is further causes the at least one processor 71: if the time when the string of characters data are obtained, in the string of characters buffer data is later than the time when the string of characters data corresponding to the URL address stored in the server are obtained, to determine that the string of characters data corresponding to the URL address stored in the server are updated relative to the string of characters buffer data; and if the time when the picture data are obtained, in the picture buffer data is later than the time when the picture data corresponding to the URL address stored in the server are obtained, to determine that the picture data corresponding to the URL address stored in the server are updated relative to the picture buffer data.

Optionally execution of the instructions by the at least one processor 71 causes the at least one processor 71: if the string of characters data corresponding to the URL address stored in the server are updated relative to the string of characters buffer data, to update text information in the generated page using the string of characters data corresponding to the URL address stored in the server; and if the picture data corresponding to the URL address stored in the server are updated relative to the picture buffer data, to update picture information in the generated page using the picture data corresponding to the URL address stored in the server.

Optionally execution of the instructions by the at least one processor 71 causes the at least one processor 71: to update the locally stored buffer data with the data corresponding to the URL address stored in the server while the generated page are being updated with the data corresponding to the URL address stored in the server.

### Sixth Embodiment

Based upon the technical solutions according to the first embodiment and the second embodiment, an embodiment of the disclosure further provides: a non-transitory computer-readable storage medium storing executable instructions that, when executed by an electronic device with a touch-sensitive display, cause the electronic device:

to receive an input page retrieval request comprising a Uniform Resource Locator (URL) address;

if there are local buffer data corresponding to the URL address, then to generate a corresponding page according to the buffer data;

to transmit the page retrieval request to the server corresponding to the URL address; and

if data corresponding to the URL address stored in the server are updated relative to the buffer data, then to update the generated page with the data corresponding to the URL address stored in the server

Optionally, the buffer data includes at least the time when the buffer data are stored; and execution of the instructions by the electronic device causes the electronic device: to obtain the time when the data corresponding to the URL address stored in the server are obtained; to compare the time when the buffer data are obtained, in the locally stored buffer data with the time when the data corresponding to the URL address stored in the server are obtained; and, if the time when the buffer data are obtained, in the buffer data is later than the time when the data corresponding to the URL address stored in the server are obtained, to determine that the data corresponding to the URL address stored in the server are updated relative to the buffer data.

Optionally the buffer data include picture buffer data and string of characters buffer data, and the data include picture data and string of characters data; and execution of the instructions by the electronic device causes the electronic device if the time when the buffer data are obtained, in the buffer data is later than the time when the data corresponding to the URL address stored in the server are obtained, to determine that the data corresponding to the URL address stored in the server are updated relative to the buffer data, is further causes the electronic device: if the time when the string of characters data are obtained, in the string of characters buffer data is later than the time when the string of characters data corresponding to the URL address stored in the server are obtained, to determine that the string of characters data corresponding to the URL address stored in the server are updated relative to the string of characters buffer data; and if the time when the picture data are obtained, in the picture buffer data is later than the time when the picture data corresponding to the URL address stored in the server are obtained, to determine that the picture data corresponding to the URL address stored in the server are updated relative to the picture buffer data.

Optionally execution of the instructions by the electronic device causes the electronic device: if the string of characters data corresponding to the URL address stored in the server are updated relative to the string of characters buffer data, to update text information in the generated page using the string of characters data corresponding to the URL address stored in the server; and if the picture data corresponding to the URL address stored in the server are updated relative to the picture buffer data, to update picture information in the generated page using the picture data corresponding to the URL address stored in the server.

Optionally execution of the instructions by the electronic device causes the electronic device: to update the locally stored buffer data with the data corresponding to the URL address stored in the server while the generated page are being updated with the data corresponding to the URL address stored in the server.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for displaying a page, executed by an electronic device the method comprising:
Receiving an input page retrieval request comprising a Uniform Resource Locator (URL) address;
if there are local buffer data corresponding to the URL address, then generating a corresponding page according to the buffer data;
transmitting the page retrieval request to the server corresponding to the URL address; and
if data corresponding to the URL address stored in the server are updated relative to the buffer data, then updating the generated page with the data corresponding to the URL address stored in the server.

2. The method according to claim 1, wherein the buffer data comprises at least the time when the buffer data are stored; and
Determining that data corresponding to the URL address stored in the server are updated relative to the buffer data comprises:
obtaining the time when the data corresponding to the URL address stored in the server are obtained;
comparing the time when the buffer data are obtained, in the locally stored buffer data with the time when the data corresponding to the URL address stored in the server are obtained; and if the time when the buffer data are obtained, in the buffer data is later than the time when the data corresponding to the URL address stored in the server are obtained, then determining that the data corresponding to the URL address stored in the server are updated relative to the buffer data.

3. The method according to claim 2, wherein the buffer data comprise picture buffer data and string of characters buffer data, and the data comprise picture data and string of characters data; and
if the time when the buffer data are obtained, in the buffer data is later than the time when the data corresponding to the URL address stored in the server are obtained, then determining that the data corresponding to the URL address stored in the server are updated relative to the buffer data comprises:
if the time when the string of characters data are obtained, in the string of characters buffer data is later than the time when the string of characters data corresponding to the URL address stored in the server are obtained, then determining that the string of characters data corresponding to the URL address stored in the server are updated relative to the string of characters buffer data; and
if the time when the picture data are obtained, in the picture buffer data is later than the time when the picture data corresponding to the URL address stored in the server are obtained, then determining that the picture data corresponding to the URL address stored in the server are updated relative to the picture buffer data.

4. The method according to claim 3, wherein updating the generated page with the data corresponding to the URL address stored in the server comprises:
if the string of characters data corresponding to the URL address stored in the server are updated relative to the string of characters buffer data, then updating text information in the generated page using the string of characters data corresponding to the URL address stored in the server; and
if the picture data corresponding to the URL address stored in the server are updated relative to the picture buffer data, then updating picture information in the generated page using the picture data corresponding to the URL address stored in the server.

5. The method according to claim 1, wherein while the generated page are being updated with the data corresponding to the URL address stored in the server, the method further comprises:
updating the locally stored buffer data with the data corresponding to the URL address stored in the server.

6. An electronic device, comprising:
at least one processor; and
a memory communicably connected with the at least one processor for storing instructions executable by the at least one processor, wherein execution of the instructions by the at least one processor causes the at least one processor:
to receive an input page retrieval request comprising a Uniform Resource Locator (URL) address;
if there are local buffer data corresponding to the URL address, then to generate a corresponding page according to the buffer data;
to transmit the page retrieval request to the server corresponding to the URL address; and
if data corresponding to the URL address stored in the server are updated relative to the buffer data, then to update the generated page with the data corresponding to the URL address stored in the server.

7. The electronic device according to claim 6, wherein the buffer data comprises at least the time when the buffer data are stored; and execution of the instructions by the at least one processor causes the at least one processor:
to obtain the time when the data corresponding to the URL address stored in the server are obtained;
to compare the time when the buffer data are obtained, in the locally stored buffer data with the time when the data corresponding to the URL address stored in the server are obtained; and
if the time when the buffer data are obtained, in the buffer data is later than the time when the data corresponding to the URL address stored in the server are obtained, to determine that the data corresponding to the URL address stored in the server are updated relative to the buffer data.

8. The electronic device according to claim 7, wherein the buffer data comprise picture buffer data and string of characters buffer data, and the data comprise picture data and string of characters data; and execution of the instructions by the at least one processor causes the at least one processor, if the time when the buffer data are obtained, in the buffer data is later than the time when the data corresponding to the URL address stored in the server are obtained, to determine that the data corresponding to the URL address stored in the server are updated relative to the buffer data, is further causes the at least one processor: if the time when the string of characters data are obtained, in the string of characters buffer data is later than the time when the string of characters data corresponding to the URL address stored in the server are obtained, to determine that the string of characters data corresponding to the URL address stored in the server are updated relative to the string of characters buffer data; and
if the time when the picture data are obtained, in the picture buffer data is later than the time when the picture data corresponding to the URL address stored in the server are obtained, to determine that the picture data corresponding to the URL address stored in the server are updated relative to the picture buffer data.

9. The electronic device according to claim 8, wherein execution of the instructions by the at least one processor causes the at least one processor:
if the string of characters data corresponding to the URL address stored in the server are updated relative to the string of characters buffer data, to update text information in the generated page using the string of characters data corresponding to the URL address stored in the server; and
if the picture data corresponding to the URL address stored in the server are updated relative to the picture buffer data, to update picture information in the generated page using the picture data corresponding to the URL address stored in the server.

10. The electronic device according to a claim 6 wherein execution of the instructions by the at least one processor causes the at least one processor:
to update the locally stored buffer data with the data corresponding to the URL address stored in the server while the generated page are being updated with the data corresponding to the URL address stored in the server.

11. A non-transitory computer-readable storage medium storing executable instructions that, when executed by an electronic device with a touch-sensitive display, cause the electronic device:
to receive an input page retrieval request comprising a Uniform Resource Locator (URL) address;
if there are local buffer data corresponding to the URL address, then to generate a corresponding page according to the buffer data;
to transmit the page retrieval request to the server corresponding to the URL address; and
if data corresponding to the URL address stored in the server are updated relative to the buffer data, then to update the generated page with the data corresponding to the URL address stored in the server.

12. The non-transitory computer-readable storage medium according to claim 11, wherein the buffer data comprises at least the time when the buffer data are stored; and execution of the instructions by the electronic device causes the electronic device:
to obtain the time when the data corresponding to the URL address stored in the server are obtained;
to compare the time when the buffer data are obtained, in the locally stored buffer data with the time when the data corresponding to the URL address stored in the server are obtained; and
if the time when the buffer data are obtained, in the buffer data is later than the time when the data corresponding to the URL address stored in the server are obtained, to determine that the data corresponding to the URL address stored in the server are updated relative to the buffer data.

13. The non-transitory computer-readable storage medium according to claim 12, wherein the buffer data comprise picture buffer data and string of characters buffer data, and the data comprise picture data and string of characters data; and execution of the instructions by the electronic device causes the electronic device, if the time when the buffer data are obtained, in the buffer data is later than the time when the data corresponding to the URL address stored in the server are obtained, to determine that the data corresponding to the URL address stored in the server are updated relative to the buffer data, is further causes the electronic device:
if the time when the string of characters data are obtained, in the string of characters buffer data is later than the time when the string of characters data corresponding to the URL address stored in the server are obtained, to determine that the string of characters data corresponding to the URL address stored in the server are updated relative to the string of characters buffer data; and
if the time when the picture data are obtained, in the picture buffer data is later than the time when the picture data corresponding to the URL address stored in the server are obtained, to determine that the picture data corresponding to the URL address stored in the server are updated relative to the picture buffer data.

14. The non-transitory computer-readable storage medium according to claim 13, wherein execution of the instructions by the electronic device causes the electronic device:
if the string of characters data corresponding to the URL address stored in the server are updated relative to the string of characters buffer data, to update text information in the generated page using the string of characters data corresponding to the URL address stored in the server; and
if the picture data corresponding to the URL address stored in the server are updated relative to the picture buffer data, to update picture information in the generated page using the picture data corresponding to the URL address stored in the server.

15. The non-transitory computer-readable storage medium according to claim 11, wherein execution of the instructions by the electronic device causes the electronic device:
to update the locally stored buffer data with the data corresponding to the URL address stored in the server while the generated page are being updated with the data corresponding to the URL address stored in the server.
